(19) United States
(12) Patent Application Publication
(10) Pub. No.: US 2026/0173231 A1
(43) Pub. Date: Jun. 18, 2026

(54) OPTICAL DEVICE AND VEHICLE INCLUDING THE SAME

(71) Applicant: HYUNDAI MOBIS CO., LTD., Seoul (KR)

(72) Inventor: Yun Ji HEO, Yongin-si (KR)

(73) Assignee: HYUNDAI MOBIS CO., LTD., Seoul (KR)

(21) Appl. No.: 19/265,052

(22) Filed: Jul. 10, 2025

(30) Foreign Application Priority Data
Dec. 16, 2024 (KR) 10-2024-0186836

(51) Int. Cl. H05B 45/14; F21S 43/14; F21S 43/249; F21S 43/31; F21Y 115/10; H05B 47/155

(52) U.S. Cl. CPC H05B 45/14; F21S 43/14; F21S 43/249; F21S 43/31; H05B 47/155; F21Y 2115/10

(57) ABSTRACT

An optical device includes a light guide to implement a lighting image by light emitted from an emission surface thereof, a first light source unit disposed at a first end of the light guide, a second light source unit disposed at a second end of the light guide, and a controller to control current applied to the first light source unit and the second light source unit to turn on and off the first light source unit and the second light source unit. The controller applies a first current signal having a first duty ratio varying over time to the first light source unit, and applies a second current signal dependent on the first current signal and having a second duty ratio varying over time to the second light source unit.

### CROSS-REFERENCE TO RELATED APPLICATIONS

This application claims the benefit of Korean Patent Application No. 10-2024-0186836, filed on Dec. 16, 2024, which is hereby incorporated by reference as if fully set forth herein.

### TECHNICAL FIELD

The disclosure relates to an optical device capable of implementing an animation effect of a lighting image through a light guide by including light source units at both ends of the light guide and controlling current applied to each light source unit, and a vehicle including the same.

### BACKGROUND

In general, a vehicle is equipped with various lamps that emit light forward depending on an ambient environment and time of day to secure a driver's vision and inform other vehicles of its traveling path.

These lamps are categorized according to the purposes of use, such as a turn signal for securing the driver's vision and indicating the position of the vehicle, together with a headlamp for illuminating ahead of the vehicle, a fog lamp for securing the driver's vision and indicating the position of the vehicle in a foggy or rainy condition, together with the headlamp, a reverse light for lighting up when the vehicle is in reverse, and a brake light for lighting up when the driver applies the brakes.

Halogen bulbs are mainly used for conventional vehicle lamps. When a halogen lamp is used as a light source, there is a reflector that reflects light irradiated by the halogen lamp, and the reflected light is irradiated forward. However, while halogen lamps have the advantage of being inexpensive, they have the disadvantages of high heat generation during use, low brightness relative to the amount of electricity used, and short lifespans.

To solve these problems, vehicle lamps using light emitting diodes (LEDs) have emerged. LED lamps have the advantages of high brightness, long lifespans, and low power consumption.

To implement various functions of the vehicle lamps, LEDs are placed to irradiate light, and a lighting image is implemented through a three-dimensional structure such as a light guide. In this case, light output from the LEDs is reflected and refracted inside the light guide to implement various forms of lighting images.

Recently, the needs of consumers for differentiation of lighting images have been gradually increasing. To meet the needs, a method of applying various shapes of light guides is generally used.

However, the method of applying various shapes of light guides alone may not fully meet the increasing needs of consumers. Accordingly, there is a need for a means for implementing differentiated lighting images.

### SUMMARY

Accordingly, the disclosure is directed to an optical device and a vehicle including the same which substantially obviate one or more problems due to limitations and disadvantages of the related art.

An aspect of the disclosure is to provide an optical device and a vehicle including the same, and more specifically, to provide an optical device capable of realizing an animation effect of a lighting image through a light guide by including a first light source unit and a second light source unit at both ends of the light guide and controlling current applied to each light source unit, and a vehicle including the same.

Another aspect of the disclosure is to provide an optical device capable of realizing an effect of moving a central light intensity within a light guide by making a first current signal applied to a first light source unit and a second current signal applied to a second light source unit dependent on each other, and a vehicle including the same.

The objects to be achieved by the disclosure are not limited to what has been particularly described hereinabove and other objects not described herein will be more clearly understood by persons skilled in the art from the following detailed description.

According to an aspect of the disclosure, an optical device includes a light guide configured to implement a lighting image by light emitted from an emission surface thereof, a first light source unit disposed at a first end of the light guide, a second light source unit disposed at a second end of the light guide, and a controller configured to control current applied to the first light source unit and the second light source unit to turn on and off the first light source unit and the second light source unit. The controller is configured to apply a first current signal having a first duty ratio varying over time to the first light source unit, and apply a second current signal dependent on the first current signal and having a second duty ratio varying over time to the second light source unit.

The controller may be configured to apply the second current signal after a first time from a time point when the first current signal is applied and overlap the first current signal and the second current signal with each other during a second time.

The controller may be configured to increase and decrease the first duty ratio and the second duty ratio over time, and decrease the first duty ratio and increase the second duty ratio during the second time.

The controller may be configured to control a sum of the first duty ratio and the second duty ratio to be 1 during the second time.

The controller may be configured to maintain the first duty ratio or the second duty ratio at a specific time point.

The first light source unit may include a plurality of first light emitting diodes (LEDs) arranged in a first direction at the first end of the light guide, and the second light source unit may include a plurality of second LEDs arranged in the first direction at the second end of the light guide.

The light guide may include a plurality of pattern members disposed on an inner surface thereof, spaced apart from each other in a second direction perpendicular to the first direction, and configured to reflect light incident from the plurality of first LEDs and the plurality of second LEDs to the emission surface.

The light guide may include a plurality of absorption members disposed on the inner surface thereof, spaced apart from each other in the second direction, and having different lengths in the first direction to selectively absorb the light incident from the plurality of first LEDs and the plurality of second LEDs.

The plurality of pattern members may have different lengths in the first direction to selectively reflect the light incident from the plurality of first LEDs and the plurality of second LEDs.

According to an aspect of the disclosure, a vehicle includes a vehicle body, a lamp structure located at a front or a rear of the vehicle body, a light guide embedded in the lamp structure and configured to implement a lighting image through light emitted from an emission surface thereof, a first light source unit disposed at a first end of the light guide, a second light source unit disposed at a second end of the light guide, and a controller configured to control current applied to the first light source unit and the second light source unit to turn on and off the first light source unit and the second light source unit. The controller is configured to apply a first current signal having a first duty ratio varying over time to the first light source unit, and apply a second current signal dependent on the first current signal and having a second duty ratio varying over time to the second light source unit.

The optical device and the vehicle including the same according to the disclosure may implement an animation effect of a lighting image through a light guide by including a first light source unit and a second light source unit at both ends of the light guide, respectively, and controlling current applied to each light source unit.

Further, an effect of moving a central light intensity in the light guide may be implemented by making a first current signal applied to the first light source unit and a second current signal applied to the second light source unit dependent on each other.

The effects that are achievable by the disclosure are not limited to what has been particularly described hereinabove and other advantages not described herein will be more clearly understood by persons skilled in the art from the following description.

### BRIEF DESCRIPTION OF DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is a block diagram illustrating an optical device according to an embodiment of the disclosure;

FIG. 2 is a diagram illustrating current applied to a first light source unit and current applied to a second light source unit in an optical device according to an embodiment of the disclosure;

FIG. 3 is a diagram illustrating a first current signal and a second current signal in an optical device according to an embodiment of the disclosure;

FIGS. 4 and 5 are diagrams illustrating a feature that a duty ratio of a first current signal and a duty ratio of a second current signal are maintained at a specific time point in an optical device according to an embodiment of the disclosure; and

FIGS. 6, 7, and 8 are diagrams illustrating a feature that a differentiated lighting image may be implemented through the shape of a light guide in an optical device according to an embodiment of the disclosure.

### DETAILED DESCRIPTION

Description will now be given in detail according to exemplary embodiments disclosed herein, with reference to the accompanying drawings. The same or equivalent components may be provided with the same reference numbers, and description thereof will not be repeated. As used herein, the suffixes “module” and “part” are added or used interchangeably to facilitate preparation of this specification and are not intended to suggest distinct meanings or functions. In describing embodiments disclosed in this specification, relevant well-known technologies may not be described in detail in order not to obscure the subject matter of the embodiments disclosed in this specification. In addition, it should be noted that the accompanying drawings are only for easy understanding of the embodiments disclosed in the present specification, and should not be construed as limiting the technical spirit disclosed in the present specification. As such, the present disclosure should be construed to extend to any alterations, equivalents and substitutes in addition to those which are particularly set out in the accompanying drawings.

Although the terms first, second, etc. may be used herein to describe various elements, these elements should not be limited by these terms. These terms are generally only used to distinguish one element from another.

It will be understood that when an element is referred to as being “connected with” another element, the element may be directly connected with the other element or intervening elements may also be present. In contrast, it will be understood that when an element is referred to as being “directly connected with” another element, there are no intervening elements present.

A singular representation may include a plural representation unless it represents a definitely different meaning from the context.

The terms such as “include” or “have” used herein are intended to indicate that features, numbers, steps, operations, elements, components, or combinations thereof used in the following description exist and it should be thus understood that the possibility of existence or addition of one or more different features, numbers, steps, operations, elements, components, or combinations thereof is not excluded.

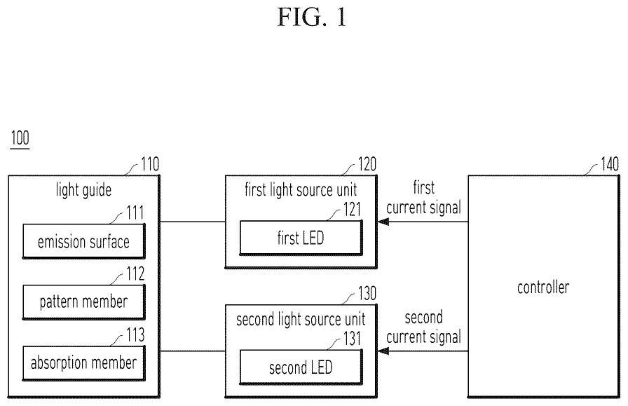

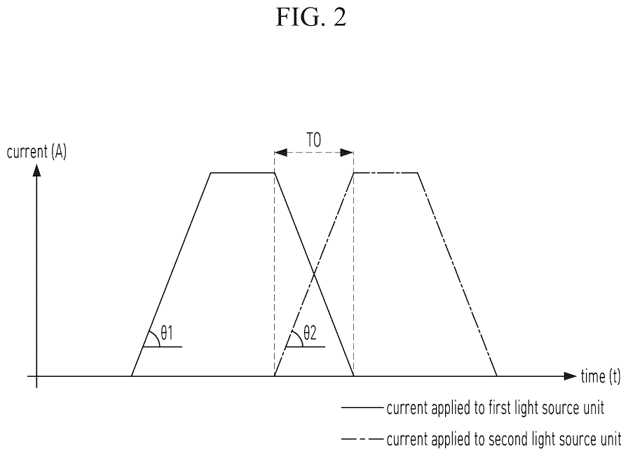

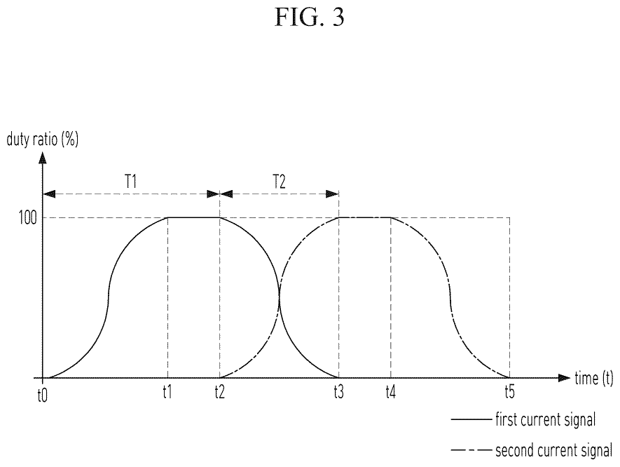

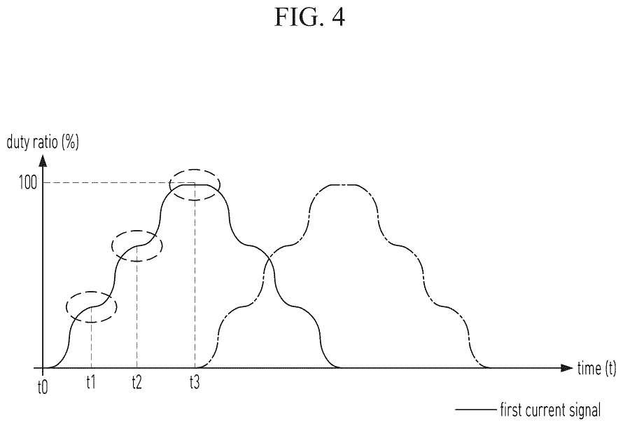

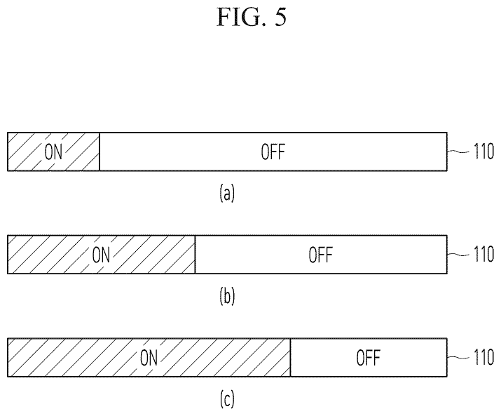

FIG. 1 is a block diagram illustrating an optical device 100 according to an embodiment of the disclosure. FIG. 2 is a diagram illustrating current applied to a first light source unit 120 and current applied to a second light source unit 130 in the optical device 100 according to an embodiment of the disclosure. FIG. 3 is a diagram illustrating a first current signal and a second current signal in the optical device 100 according to an embodiment of the disclosure. FIGS. 4 and 5 are diagrams illustrating a feature that a duty ratio of the first current signal and a duty ratio of the second current signal are maintained at a specific time point in the optical device 100 according to an embodiment of the disclosure.

Referring to FIG. 1 together, the optical device 100 according to an embodiment of the disclosure may include a light guide 110, the first light source unit 120 and the second light source unit 130 disposed at both ends of the light guide 110, respectively, and a controller 140 controlling the current applied to the first light source unit 120 and the second light source unit 130 such that they are turned on and off.

The light guide 110 may serve to implement a lighting image through light emitted through an emission surface 111 thereof. The first light source unit 120 may be disposed at one end of the light guide 110, and the second light source unit 130 may be disposed at the other end of the light guide 110.

The light guide 110, which is a three-dimensional structure, may reflect and refract light incident from the first light source unit 120 and the second light source unit 130 internally, such that the light is emitted through the emission surface 111. That is, the light incident from both ends of the light guide 110 may be reflected and refracted on an inner surface of the light guide 110 to the emission surface 111, thereby implementing a lighting image.

To this end, a pattern member 112 for reflecting incident light may be formed on the inner surface of the light guide 110. In addition, an absorption member 113 may be formed on the inner surface of the light guide 110 to clarify a light-emitting area of light emitted through the emission surface 111 in order to effectively implement the lighting image through the light guide 110. More specific details of this will be described later.

Further, a vehicle including the optical device 100 according to an embodiment of the disclosure may include a vehicle body and a lamp structure located at a front or rear of the vehicle body, the light guide 110 may be embedded in the lamp structure, and the first light source unit 120 and the second light source unit 130 may be disposed at both ends of the light guide 110.

Particularly, in the optical device 100 according to an embodiment of the disclosure, the controller 140 may apply a first current signal having a duty ratio varying over time to the first light source unit 120. The controller 140 may also apply a second current signal, which is dependent on the first current signal and has a duty ratio varying over time, to the second light source unit 130.

As described above, the needs of consumers for differentiating lighting images have been gradually increasing, and generally, a method of applying various shapes of the light guide 110 being a three-dimensional structure has been used.

However, there was a limitation in that the method of applying various shapes of the light guide 110 alone could not fully satisfy the increasing needs of consumers. Accordingly, a means for implementing a differentiated lighting image is required, and the optical device 100 according to an embodiment of the disclosure aims to solve the problem.

Therefore, the optical device 100 according to an embodiment of the disclosure may implement an animation effect of a lighting image through the light guide 110 by controlling current applied to the first light source unit 120 and the second light source unit 130 through the controller 140. In particular, an effect of moving a central light intensity within the light guide 110 may be implemented by making the first current signal applied to the first light source unit 120 and the second current signal applied to the second light source unit 130 dependent on each other, thereby realizing a differentiated lighting image.

Referring to FIGS. 1 and 2 together, in the optical device 100 according to an embodiment of the disclosure, the controller 140 may apply current that varies over time to the first light source unit 120 disposed at one end of the light guide 110.

The controller 140 may sequentially apply current that varies over time to the second light source unit 130 disposed at the other end of the light guide 110. This may enable the optical device 100 according to an embodiment of the disclosure to turn on and off the first light source unit 120 and the second light source unit 130 with changing brightness, and implement a differentiated lighting image through the light guide 110.

In particular, the optical device 100 according to an embodiment of the disclosure may implement an effect of moving a central light intensity within the light guide 110 based on a time T0 during which current is simultaneously applied to the sequentially turned-on first light source unit 120 and second light source unit 130.

Further, the optical device 100 according to an embodiment of the disclosure may change an inclination ?1 of the current applied to the first light source unit 120, which increases over time and an inclination ?2 of the current applied to the second light source unit 130, which increases over time, and control the magnitude of the current applied to the first light source unit 120 and the magnitude of the current applied to the second light source unit 130, through the controller 140.

More specifically, referring to FIG. 3 together, in the optical device 100 according to an embodiment of the disclosure, the controller 140 may apply the first current signal having a duty ratio varying over time to the first light source unit 120, and apply the second current signal, which is dependent on the first current signal and has a duty ratio varying over time, to the second light source unit 130.

The controller 140 may allow the second current signal to be applied after a first time T1 from a time point t0 when the first current signal is applied. Therefore, the first time T1 may be the difference between the time point t0 when the first current signal is applied and a time point t2 when the second current signal is applied. The controller 140 may also control the first current signal and the second current signal to overlap with each other during a second time T2.

As described above, the optical device 100 according to an embodiment of the disclosure may implement the effect of moving the central light intensity within the light guide 110 based on the second time T2 during which the first current signal and the second current signal overlap with each other.

Further, in the optical device 100 according to an embodiment of the disclosure, the controller 140 may control to increase and decrease the duty ratio of the first current signal and the duty ratio of the second current signal over time. The controller 140 may also control the duty ratio of the first current signal to decrease and the duty ratio of the second current signal to increase during the second time T2.

Additionally, in the optical device 100 according to an embodiment of the disclosure, the controller 140 may control the sum of the duty ratio of the first current signal and the duty ratio of the second current signal to be 1 during the second time T2.

FIG. 3 is a diagram illustrating changes in the duty ratios of the first current signal and the second current signal over time, when the duty ratios are converted into percentages %. That is, the controller 140 may control the sum of the decreasing duty ratio of the first current signal and the increasing duty ratio of the second current signal to be 100% during the second time T2.

This may enable the optical device 100 according to an embodiment of the disclosure to implement the animation effect of a lighting image described above by sequentially applying the second current signal, which is dependent on the first current signal applied to the first light source unit 120, to the second light source unit 130 through the controller 140 such that the first light source unit 120 and the second light source unit 130 disposed at both ends of the light guide 110 are sequentially turned on and off.

Referring to FIGS. 4 and 5 together, in the optical device 100 according to an embodiment of the disclosure, the controller 140 may control the duty ratio of the first current signal or the duty ratio of the second current signal to be maintained at a specific time point. For example, as illustrated in FIG. 4, the duty ratio of the first current signal, which increases over time, may be maintained at time points t1, t2, and t3.

FIG. 5 is a diagram illustrating areas of the light guide 110, which are illuminated according to time periods during which the duty ratio is maintained at the above-described specific time points. FIG. 5(a) illustrates an area of the light guide 110 illuminated by the first light source unit 120 during time points t0 to t1 of FIG. 4, and FIG. 5(b) illustrates an area of the light guide 110 illuminated by the first light source unit 120 during time points t1 to t2 of FIG. 4. FIG. 5(c) illustrates an area of the light guide 110 illuminated by the first light source unit 120 during time points t2 to t3 of FIG. 4.

That is, the optical device 100 according to an embodiment of the disclosure may implement the animation effect of a lighting image through the light guide 110 by controlling the duty ratio of the first current signal or the duty ratio of the second current signal to be maintained at a specific time point through the controller 140, such that the illuminated areas of the light guide 110 sequentially move.

According to the above description, the effect of moving the central light intensity may also be implemented through the first light source unit 120 and the second light source unit 130, which are disposed at both ends of the light guide 110 and are turned on and off, by maintaining the duty ratio of the second current signal, which is dependent on the first current signal, at a specific time point.

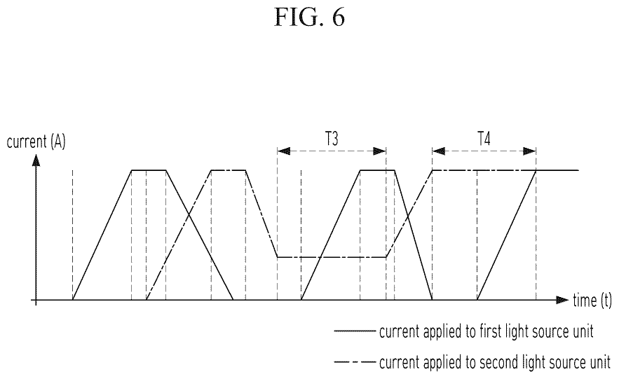

FIGS. 6 to 8 are diagrams illustrating a feature that a differentiated lighting image may be implemented through the shape of the light guide 110 in the optical device 100 according to an embodiment of the disclosure.

In the optical device 100 according to an embodiment of the disclosure, the light guide 110, which is a three-dimensional structure as described above, may reflect and refract light incident from the first light source unit 120 and the second light source unit 130 internally, such that the light is emitted through the emission surface 111. In addition, the light guide 110 may be formed in a bent structure including a plurality of bent portions. Various shapes of the light guide 110 are effective in implementing various lighting images as described above.

The optical device 100 according to an embodiment of the disclosure may use the bent structure of the light guide 110 to control diverse variabilities of the current applied to the first light source unit 120 and the current applied to the second light source unit 130 through the controller 140, as illustrated in FIG. 6.

For example, the current applied to the second light source unit 130 may be maintained without increasing or decreasing during times T3 and T4. In addition, the change over time of the current applied to the first light source unit 120 and the current applied to the second light source unit 130 may be diversified. Through this, a differentiated lighting image corresponding to the shape of the light guide 110 may be implemented.

However, despite the variable control of the applied current as illustrated in FIG. 6, a phenomenon in which light is lost at the bent portions of the light guide 110 may occur. This phenomenon may limit the implementation of the animation effect of a lighting image through the light guide 110 described above.

Referring to FIG. 1, in the optical device 100 according to an embodiment of the disclosure, the first light source unit 120 may include a plurality of first LEDs 121 arranged in a first direction (y-axis direction) at the one end of the light guide 110. The second light source unit 130 may also include a plurality of second LEDs 131 arranged in the first direction (y-axis direction) at the other end of the light guide 110.

That is, the optical device 100 according to an embodiment of the disclosure may form various paths of light entering the light guide 110 through the plurality of first LEDs 121 and the plurality of second LEDs 131 arranged in the first direction (y-axis direction) at both ends of the light guide 110. This may minimize the phenomenon of light loss at the bent portions of the light guide 110.

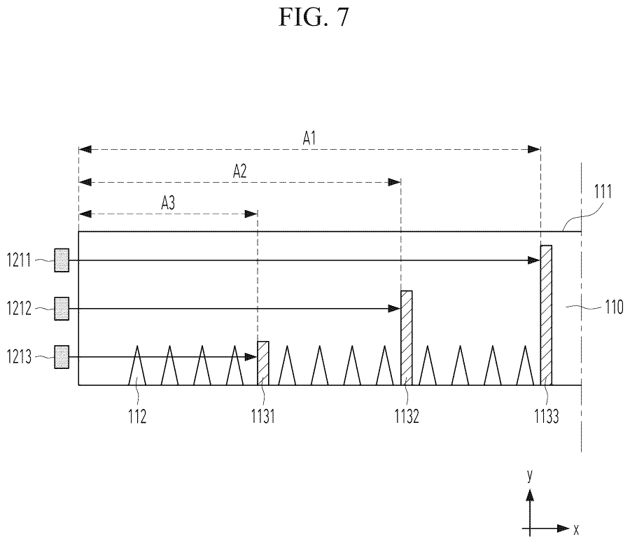

For example, referring to FIG. 7 together, a (1-1)th LED 1211, a (1-2)th LED 1212, and a (1-3)th LED 1213 may be arranged in the first direction (y-axis direction) at the one end of the light guide 110, thereby forming various paths of light entering the light guide 110. This may minimize light loss and allow implementation of various lighting images, even if the shape of the light guide 110 is variously formed as described above.

Further, in the optical device 100 according to an embodiment of the disclosure, the light guide 110 may include a plurality of pattern members 112 which are formed on the inner surface thereof, spaced apart from each other in a second direction (x-axis direction) perpendicular to the first direction, and reflect light incident from the plurality of first LEDs 121 and the plurality of second LEDs 131 to the emission surface 111.

Particularly, referring to FIGS. 1 and 7 together, in the optical device 100 according to an embodiment of the disclosure, the light guide 110 may include a plurality of absorption members 113 which are formed on the inner surface thereof, spaced apart from each other in the second direction (x-axis direction) and having different lengths in the first direction (y-axis direction) to selectively absorb light incident through the plurality of first LEDs 121 and the plurality of second LEDs 131.

For example, as illustrated in FIG. 7, the (1-1)th LED 1211, the (1-2)th LED 1212, and the (1-3)th LED 1213 may be arranged in the first direction (y-axis direction) at the one end of the light guide 110. A plurality of absorption members 1131, 1132, and 1133 having different lengths in the first direction (y-axis direction) may be formed inside the light guide 110.

The plurality of absorption members 1131, 1132, and 1133 having different lengths in the first direction (y-axis direction) may absorb light incident through the (1-1)th LED 1211, the (1-2)th LED 1212, and the (1-3)th LED 1213 arranged in the first direction (y-axis direction), respectively, thereby making clear distinction among light-emitting areas A1, A2, and A3 of light emitted through the emission surface 111 of the light guide 110.

That is, in the optical device 100 according to an embodiment of the disclosure, various paths of light entering the light guide 110 may be formed by arranging the plurality of first LEDs 121 and the plurality of second LEDs 131 at both ends of the light guide 110, and the plurality of absorption members 1131, 1132, and 1133 may be formed to implement the animation effect of lighting images in various shapes such as the bent structure of the light guide 110. This may minimize light loss by making clear distinction among the light-emitting areas A1, A2, and A3 of light emitted through the emission surface 111 of the light guide 110.

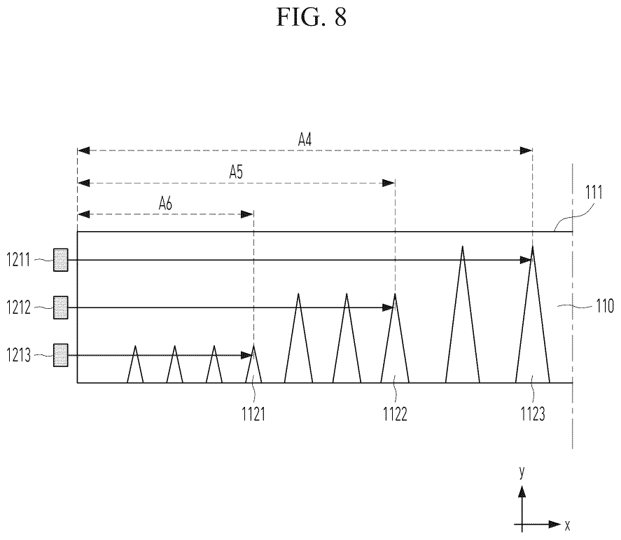

Further, to implement the above-described effect, in the optical device 100 according to an embodiment of the disclosure, a plurality of pattern members 1121, 1122, and 1123 may be formed to have different lengths in the second direction (y-axis direction) for selectively reflecting light incident through the plurality of first LEDs 121 and the plurality of second LEDs 131, as illustrated in FIG. 8.

In this case, the above-described absorption members 113 may be omitted, and a light-absorbing material may be applied to some of the plurality of pattern members 1121, 1122, and 1123. That is, some of the plurality of pattern members 1121, 1122, and 1123 may reflect light incident through the (1-1)th LED 1211, the (1-2)th LED 1212, and the (1-3)th LED 1213 arranged in the first direction (y-axis direction) at the one end of the light guide 110 to the emission surface 111, while the others may absorb light.

This may minimize light loss by making clear distinction among light-emitting areas A4, A5, and A6 of light emitted through the emission surface 111 of the light guide 110. Therefore, various paths of light entering the light guide 110 may be formed, and the animation effect of a lighting image may be implemented in various shapes such as the bent structure of the light guide 110.

In summary, the optical device and the vehicle including the same according to the disclosure may implement the animation effect of a lighting image through the light guide by including the first light source unit and the second light source unit at both ends of the light guide and controlling current applied to each light source unit. Further, the effect of moving a central light intensity within the light guide may be implemented by making the first current signal applied to the first light source unit and the second current signal applied to the second light source unit dependent on each other.

The above detailed description is to be construed in all aspects as illustrative and not restrictive. The scope of the disclosure should be determined by reasonable interpretation of the appended claims and all changes coming within the equivalency range of the disclosure are intended to be embraced in the scope of the disclosure.

What is claimed is:

1. An optical device comprising:
a light guide configured to implement a lighting image by light emitted from an emission surface thereof;
a first light source unit disposed at a first end of the light guide;
a second light source unit disposed at a second end of the light guide; and
a controller configured to control current applied to the first light source unit and the second light source unit to turn on and off the first light source unit and the second light source unit,
wherein the controller is configured to:
apply a first current signal having a first duty ratio varying over time to the first light source unit; and
apply a second current signal dependent on the first current signal and having a second duty ratio varying over time to the second light source unit.

2. The optical device according to claim 1, wherein the controller is configured to apply the second current signal after a first time from a time point when the first current signal is applied and overlap the first current signal and the second current signal with each other during a second time.

3. The optical device according to claim 2, wherein the controller is configured to increase and decrease the first duty ratio and the second duty ratio over time, and
wherein the controller is configured decrease the first duty ratio and increase the second duty ratio during the second time.

4. The optical device according to claim 3, wherein the controller is configured to control a sum of the first duty ratio and the second duty ratio to be 1 during the second time.

5. The optical device according to claim 1, wherein the controller is configured to maintain the first duty ratio or the second duty ratio at a specific time point.

6. The optical device according to claim 1, wherein the first light source unit includes a plurality of first light emitting diodes (LEDs) arranged in a first direction at the first end of the light guide, and
wherein the second light source unit includes a plurality of second LEDs arranged in the first direction at the second end of the light guide.

7. The optical device according to claim 6, wherein the light guide includes a plurality of pattern members disposed on an inner surface thereof, spaced apart from each other in a second direction perpendicular to the first direction, and configured to reflect light incident from the plurality of first LEDs and the plurality of second LEDs to the emission surface.

8. The optical device according to claim 7, wherein the light guide includes a plurality of absorption members disposed on the inner surface thereof, spaced apart from each other in the second direction, and having different lengths in the first direction to selectively absorb the light incident from the plurality of first LEDs and the plurality of second LEDs.

9. The optical device according to claim 7, wherein the plurality of pattern members have different lengths in the first direction to selectively reflect the light incident from the plurality of first LEDs and the plurality of second LEDs.

10. A vehicle comprising:
a vehicle body;
a lamp structure located at a front or a rear of the vehicle body;
a light guide embedded in the lamp structure and configured to implement a lighting image through light emitted from an emission surface thereof;
a first light source unit disposed at a first end of the light guide;
a second light source unit disposed at a second end of the light guide; and
a controller configured to control current applied to the first light source unit and the second light source unit to turn on and off the first light source unit and the second light source unit,
wherein the controller is configured to:
apply a first current signal having a first duty ratio varying over time to the first light source unit; and
apply a second current signal dependent on the first current signal and having a second duty ratio varying over time to the second light source unit.
